(19) United States
(12) Patent Application Publication
(10) Pub. No.: US 2021/0201239 A1
(43) Pub. Date: Jul. 1, 2021

(54) ADAPTIVE TIMELINE INTERFACE FOR FACILITATING THE ACHIEVEMENT OF GOALS

(71) Applicant: LendingClub Corporation, San Francisco, CA (US)

(72) Inventors: Thom Milkovic, San Francisco, CA (US); Phillip La, San Francisco, CA (US); Steven J. Lemanski, San Francisco, CA (US)

(21) Appl. No.: 16/732,086

(22) Filed: Dec. 31, 2019

(51) Int. Cl. G06Q 10/06; G06Q 30/02; G06Q 40/02; G06F 3/0482; G06F 3/0484

(52) U.S. Cl. CPC G06Q 10/06316; G06Q 30/0208; G06F 3/0484; G06Q 40/02; G06F 3/0482; G06Q 30/0239

(57) ABSTRACT

A user-interface is provided for facilitating the achievement of goals. The goals that are facilitated using the interface may vary from implementation to implementation. The interface includes an event timeline that has a chronologically-ordered series of event entries. The event entries indicate tasks associated with a plan for achieving one or more goals specified by the user. The plan is automatically determined by an automated service based on the user's specified goals, the timing/priority specified for those goals, and information about the user obtained from sources other than the user. The automated service periodically collects information from those sources to determine whether the user performs the specified tasks in compliance with the timings specified in the plan. In response to determining non-compliance, the service automatically revises the plan and generates a revised event timeline with event entries for tasks in the revised plan. The interface may include a metric timeline that displays predicted future values of a metric associated with one or more of the user's goals. A “now-line” in the metric timeline may move automatically in sync with the user scrolling the event timeline.

### FIELD OF THE INVENTION

The present invention relates to software and, more specifically, to an application that generates a timeline interface for facilitating the achievement of goals.

### BACKGROUND

One's success at anything often hinges on the ability to set goals, and then perform the tasks necessary to achieve those goals. Unfortunately, performing those tasks is often far more difficult than setting the goals themselves. In fact, in many situations, it is not clear what tasks will result in achieving a goal. When it is not clear what tasks are needed to achieve a goal, the likelihood that the goal will be achieved is significantly reduced.

It is well-established that positive reinforcement for a behavior increases the likelihood that the behavior will occur. For example, a teenager that has been promised a car upon earning the Eagle Scout award is more likely to earn the Eagle Scout award than if no such promise were made. Thus, the achievement of difficult goals is facilitated in situations in which (a) the tasks for achieving the goals are well-defined, and (b) positive reinforcement is provided for performing those tasks.

Unfortunately, in many real-world scenarios, the tasks and incentives for achieving a goal are not well understood. For example, a user that plans on eventually buying a home may adopt the goal of “becoming more financially sound” without any clear idea of how to go about pursuing that goal. Further, the incentive for pursuing the goal may be little more than a vague notion that improved financial health may increase the user's credit scores, and increased credit scores may result in lower interest rates on mortgages. Without a clear picture with respect to the specific tasks that will improve financial health, along with a clear understanding of the specific benefits that will result therefrom, the likelihood of significant financial health improvement is low.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1A illustrates a preliminary screen that may be generated by a mobile application provided by a lending company, according to an embodiment;

FIG. 1B illustrates a screen the displays information about a user's credit card accounts, according to an embodiment;

FIG. 1C illustrates the interface of FIG. 1B after a user has scrolled up to see information about additional credit cards, according to an embodiment;

FIG. 1D illustrates the interface of FIG. 1C after the user has swiped left on the depictions of a credit card to display further information, according to an embodiment;

FIG. 1E illustrates the interface generated by the mobile application when the “Other Loans” subheading is selected, according to an embodiment;

FIG. 2A illustrates the mobile application of FIG. 1A when the “Credit Health” heading is selected, according to an embodiment;

FIG. 2B illustrates a screen that the mobile application may generate in response to selecting the control next to the credit score illustrated in FIG. 2A, according to an embodiment;

FIG. 3A illustrates an event timeline interface, according to an embodiment;

FIG. 3B illustrates a dual-timeline interface that includes the event timeline illustrated in FIG. 3A, according to an embodiment;

FIG. 3C illustrates the dual-timeline interface of FIG. 3B after the user has scrolled the event timeline up to reveal a future-reward entry, according to an embodiment;

FIG. 3D illustrates the dual-timeline interface of FIG. 3C where the user has scrolled to reveal to task events for tasks to be performed in the future, according to an embodiment;

FIG. 3E illustrates the dual-timeline interface after the user has scrolled further into the portion of the timeline that represents the future, according to an embodiment;

FIG. 3F illustrates the dual-timeline interface of FIG. 3E after the user has scrolled to completely reveal a reward-achieved entry, according to an embodiment;

FIG. 3G illustrates the dual-timeline interface of FIG. 3E after the six months have passed and the user has performed all tasks necessary to achieve the specified reward, according to an embodiment; and

FIG. 4 is a block diagram of a computer system that may be used to generate the dual-timeline interface described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A user-interface is provided for facilitating the achievement of goals. The goals that are facilitated using the interface may vary from implementation to implementation. For example, the interface may be used to facilitate a weight-loss goal, a get-out-of-debt goal, a retirement goal and/or a goal of saving for a significant purchase. Thus, there is virtually no limit to the types of goals whose achievement may be facilitated through use of the interface described herein.

In one embodiment, the user interface includes an “event timeline.” The event timeline includes “task entries” that identify specific tasks whose performance furthers the user's efforts to achieve a particular goal. The task entries are positioned within the timeline display based on the times at which the tasks should be performed. For example, in the case where the goal is to improve the financial health of a user, the timeline may have three “Make loan payment on time” task entries. The three task entries may be located, within the timeline, at locations that correspond to the end of each of the next three months.

In addition, the event timeline has “reward entries” that identify specific rewards that will result from performing the tasks in the preceding task entries. The reward entries are positioned within the timeline based on when the specified rewards will be realized or become available. Thus, immediately following the third task entry, there may be a reward entry that indicates “interest rate on loan reduced from 5% to 4.5%”. The reward entry indicates what reward will occur if the tasks in the preceding task entries are performed on time.

In one embodiment, the user interface includes a second timeline, referred to herein as the “metric timeline”. According to an embodiment, the metric timeline includes a graph of the value of a metric that corresponds to a user's goal. For example, for the goal of “getting out of (unsecured) debt”, the metric timeline may be a graph illustrating the amount of the user's unsecured debt over time. The current and past values of the metric may be based on actual data gathered from available sources, while the future values of the metric may be projections based on the assumption that the user performs the tasks indicated in the task entries on the event timeline that are scheduled to occur in the future.

According to an embodiment, content of both timelines automatically adjusts based on new information gathered by the service for which the interface is generated. For example, assume that a lending company provides a service that includes a mobile application that generates the event timeline/metric timeline interface (the “dual-timeline interface”). Assume further that the goals are “get out of debt” and “buy a house”. Assume further that the service gathers financial information for the user that indicates that the user made a major purchase using a credit card. Based on this information, the graph of “the debt metric” would dynamically change to account for the new debt. In addition, one or more events relating to getting out of debt may be added, removed, time-shifted, or changed based on the new expenditure.

### Financial Goals Example

For the purpose of illustration, it shall be assumed that the interface described herein is an interface generated by a mobile application provided by a lender to assist the lender's customers in achieving financial goals, such as getting out of debt and/or buying a house. However, financial goals are merely one example of the virtually limitless types of goals whose achievement may be facilitated by the dual-timeline interface described herein. Other types of goals whose achievement may be facilitated by the dual-timeline interface include, but are not limited to health-related goals (e.g. achieving a target weight, a target fat %, or running a marathon), career-related goals (e.g. making a target number of sales, or preparing for a licensing examination), academic goals (e.g. achieving a certain GPA, or obtaining a certain degree), etc.

For the purpose of illustration, it shall be assumed that the user has provided the information that allows the application to connect to the data sources that will have information relevant to achieving the specified goals. In the present example, the user has the two goals of buying a house and getting out of debt. The data sources that have information relevant to achieving those goals may include, but are not limited to, the user's bank accounts, credit card accounts, and loans (which may include both loans with the lending company that is providing the application, and with third-party lenders). The data sources may also include one or more credit bureaus.

According to one embodiment, the preliminary screens, in conjunction with the dual-timeline interface:
help the user understand their current state. In the case of financial goals, the current state may include, for example, the user's current “credit health”.
help the user understand what services/products the user qualifies for to further their specified goals. For financial goals, those services/products may include short or long-term loans, opportunities to consolidate and/or refinance existing loans, etc.
chart a clear path to achieve the user's specified goals through the use of those services/products.

In some cases, the terms of certain services/products may not be appealing to a user. For example, the user may currently qualify for refinancing a car loan at 19% APR, but the user desires to refinance at 15% APR. In such situations, the user's financial goals may include qualifying to refinance at 15% APR. In such situations, after specifying that goal, the event timeline may be updated to include task entries for tasks which, if performed, would allow the user to qualify to refinance at 15% APR. Those task entries would be followed by an event entry that indicates that the user qualifies for the desired terms. The “refinance at 15%” entry would be positioned within the timeline based on the when the user would qualify for the desired terms. The timing of the “refinance at 15%” entry would be based on the assumption that (a) the user performs all tasks indicated in all of the related task events, and (b) those tasks are performed at the times that comply with the timings of the corresponding event entries in the event timeline.

### Timing of Goal Achievement

According to one embodiment, the timing of goal achievement may be user-specified or automatically determined. An example of user-specified timing is where the user specifies that the user desires to refinance at 15% in two months. Based on both the goal and the user-specified time for achieving the goal, the service determines what tasks the user would have to perform to achieve the goal in the specified time period. In one embodiment, rather than simply informing the user that achieving the specified task in the specified time period is impossible, the service generates the tasks that would achieve the goal in the time period, even though performance of those tasks is improbably. For example, to refinance at 15% in two months, the service may generate the tasks of paying down $50,000 of credit card debt within the first month, and $25,000 more in credit card debt the second month. If the specified tasks do no appear attainable by the user, the user may lengthen the time target for the goal (e.g. refinance at 15% in 12 months), or may simply drop the time target and allow the service to specify both the tasks and the time period at which the goal will be achieved.

In the case where the user does not specify a particular time target for achieving a goal, the service may automatically select tasks that achieve the goal without placing an unrealistic burden on the lender. After selecting the tasks, the timing of goal achievement is determined based on the selected tasks.

### Degree of Sacrifice Setting

According to one embodiment, rather than specify a time for achieving a goal, the user specifies a “degree of sacrifice” the user is willing to make to achieve the goal. The higher the degree of sacrifice, the more difficult the tasks that are selected by the service. As a general rule, the more difficult the tasks, the less time it will take to achieve the specified goal. For example, in response to a user specifying a high degree of sacrifice, the service may generate tasks to aggressively pay down credit card debt. On the other hand, a low degree of sacrifice setting may generate tasks for a less aggressive pay down of credit card debt, which may push achievement of the specified goal further into the future.

By repeatedly adjusting the degree of sacrifice setting and seeing the effect it has on the difficulty of the tasks in the event timeline and the timing of goal achievement, the user can pick a setting that fits the user's desired balance between the timing of goal achievement and the difficulty of the corresponding tasks.

### Preliminary Screens

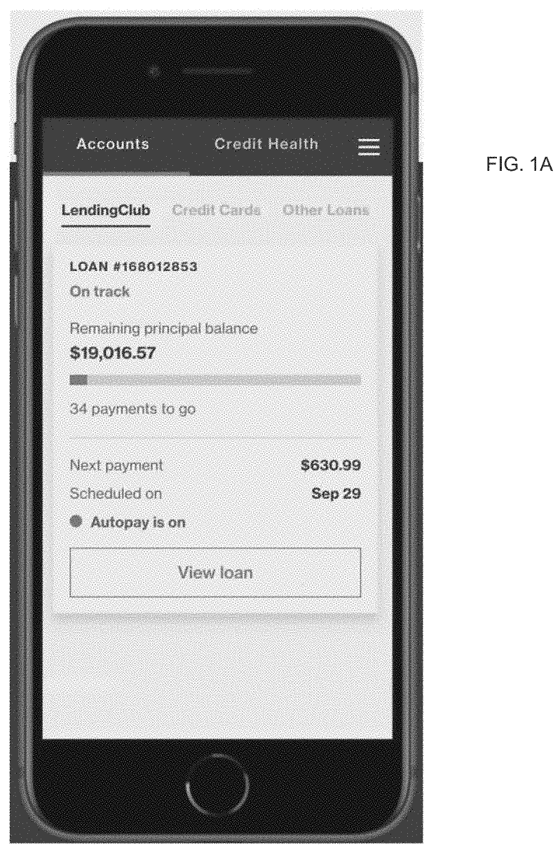

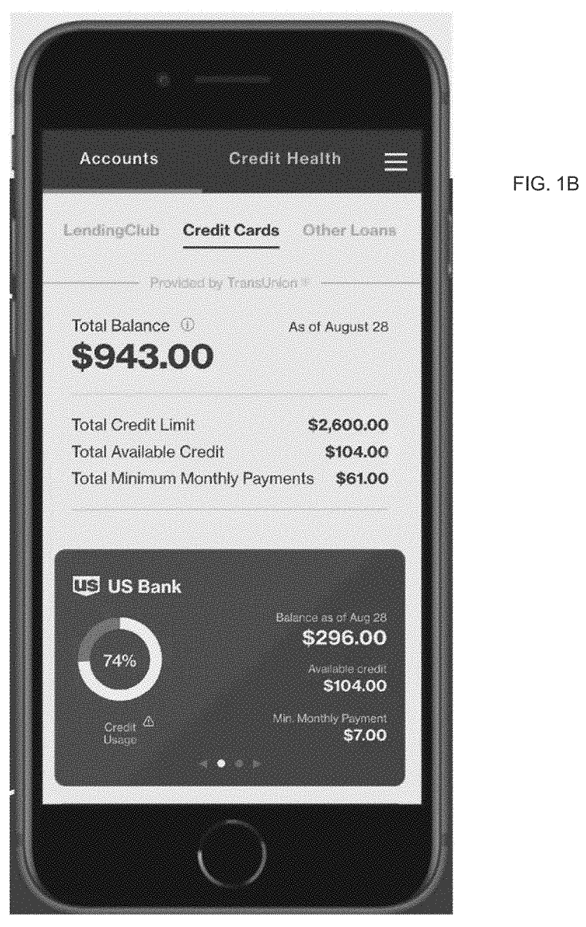

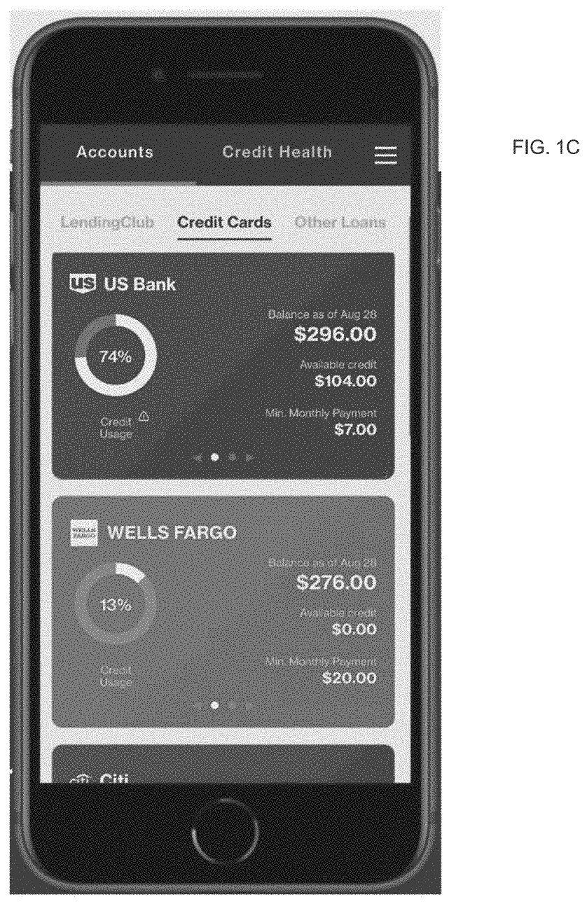

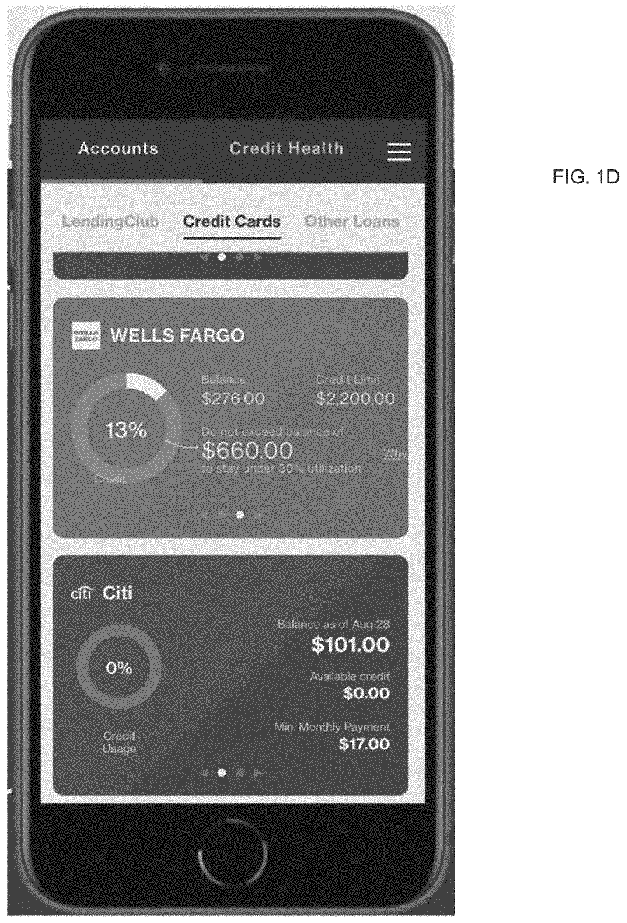

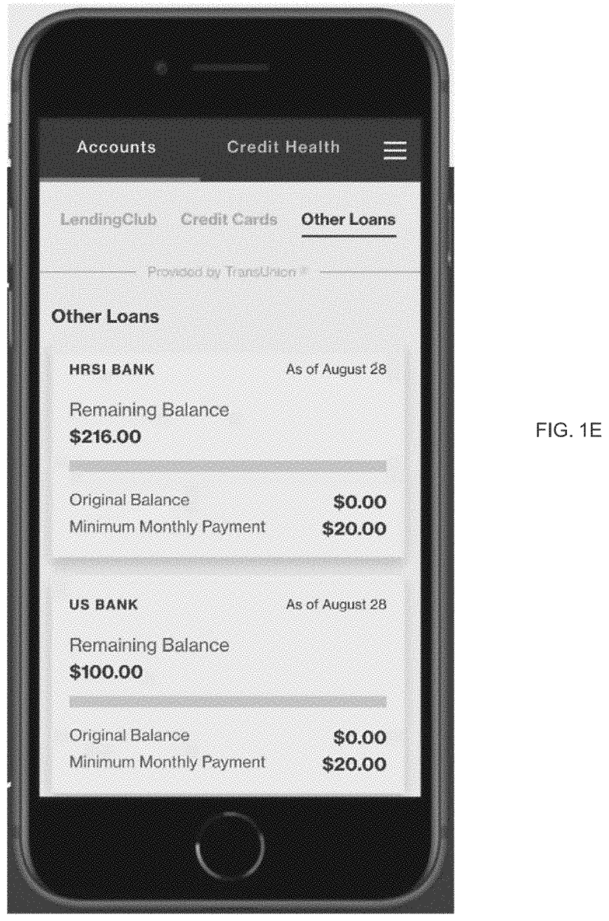

Referring to FIG. 1A, it illustrates a preliminary screen that may be generated by a mobile application provided by a lending company. In the interface illustrated in FIG. 1A, the user has two main heading “Accounts” and “Credit Health”. In FIG. 1A, the “Accounts” heading is selected, showing three subheadings “LendingClub”, “Credit Cards”, and “Other Loans”. In the present example, “LendingClub” is the name of the lending company that is providing the service with which the mobile application is used. In FIG. 1A, the “LendingClub” subheading is selected, causing the interface to show all of the accounts the user has with the lending company. In the present example, the user has a single loan. The interface displays various pieces of information about the loan, including the remaining principal balance, whether the loan is “on track”, the amount and timing of the next payment, etc. A button is provided which, when activated, allows the user to see further details about the loan in question. In the case that the user had multiple loans, the user would be able to scroll the screen up (or swipe left/right) to view similar information about each of the loans.

Referring to FIG. 1B, it illustrates a preliminary screen generated by the mobile application when the “Credit Cards” subheading is selected. In FIG. 1B, the interface displays information about one of the user's credit card accounts. The information includes the current balance, the credit limit, minimum payments, etc. In the case where the user has multiple credit card accounts, the user may either scroll up or swipe horizontally to see the information for the individual credit card accounts.

FIG. 1C illustrates the interface of FIG. 1B after a user has scrolled up to see information about additional credit cards. In the illustrated embodiment, the user may swipe left on the depiction of any credit card to obtain additional information about the credit card account. For example, FIG. 1D illustrates the interface of FIG. 1C after the user has swiped left on the depictions of a “Wells Fargo” credit card. In FIG. 1D, the mobile application has added the suggestion that the user not exceed a balance of $660 in order to stay under 30% utilization of the credit line.

FIG. 1E illustrates the interface generated by the mobile application when the “Other Loans” subheading is selected. In the present example, information about two “other loans” are shown. Similar to the credit card account display, scrolling up may reveal additional loans, and swiping horizontally may reveal additional information about the other loans.

As mentioned above, the mobile application may be configured to obtain the financial information for the user from various sources, including both the accounts that the user has with the party that is providing the service associated with the mobile application (e.g. “LendingClub”), and with third-party data sources, such as banks, other financial institutions, and credit bureaus. In addition, the user interface may provide controls that allow the user to enter relevant information about any additional source from which data cannot be automatically gathered. For example, the mobile application may provide controls that allow the user to specify that the user has a loan from his/her mother for $2,000 at a particular interest rate for a particular term.

### Credit Health View

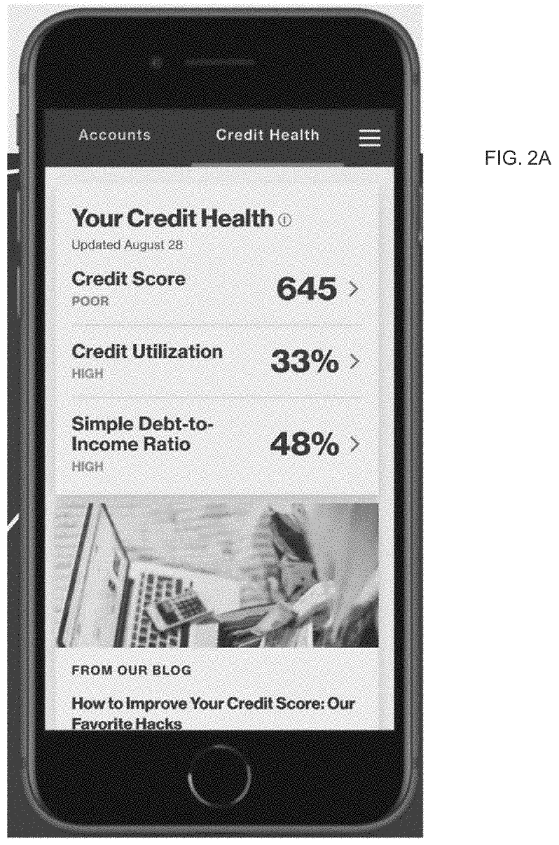

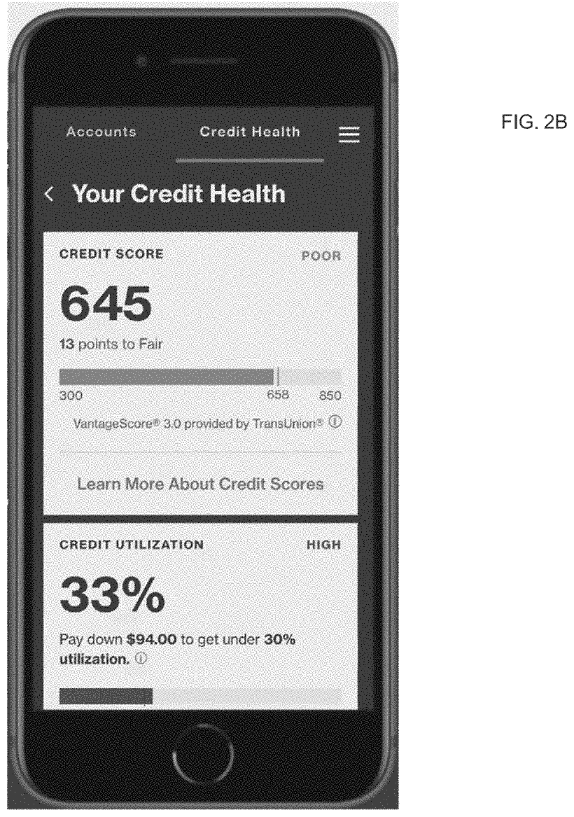

Referring to FIG. 2A, it illustrates the mobile application of FIG. 1A when the “Credit Health” heading is selected. Unlike the “Accounts” screens illustrated in FIGS. 1A to 1E, which relate to individual accounts, the “Credit Health” screen illustrated in FIG. 2A gives an overview of the user's entire financial situation, including but not limited to information from the individual accounts.

In the illustrated example, the “Credit Health” screen includes a credit score, a credit utilization rate, and a debt-to-income ratio. With each of these values, the application includes an evaluation of the corresponding value. In the present example, the credit score is “poor”, the credit utilization is “high” and the debt-to-income ratio is also “high”.

Next to each of the health score values is a control which, if selected, causes the mobile application to generate a screen that includes more information about the score. Such information may include details about how the score is derived, what constitutes “good”, “normal” and “poor” scores, and optionally tips on how to improve the score. For example, FIG. 2B illustrates a screen that the mobile application may generate in response to selecting the control next to the credit score illustrated in FIG. 2A. Referring to FIG. 2B, the mobile application generates a display that indicates that the user's current credit score is 13 points below “Fair”, and that the credit score can be improved by paying down $94 of debt to get under 30% utilization of available credit.

### Specifying and Prioritizing Goals

The preliminary screens and credit health information provided by the mobile application provide the user with a good understanding of the user's current state, and how to generally improve the user's financial situation. In other contexts, the preliminary and overview screens will serve a similar purpose. For example, in the context of achieving health goals, the “Accounts” screens may be replaced with the user's latest test results showing cholesterol levels, blood sugar levels, blood pressure, etc. Similarly, “credit health” screens may be replaced with “physical health” screens that attempt to convey the user's overall health. For example, the user may be presented with an “overall health” score that assigns the user a number between 1 and 100, where 1 corresponds to incapacitated and 100 corresponds to perfect health.

Once the user is adequately informed of his/her current state and has been given tips on how to improve that state, the user should be ready to formulate specific goals. For the purpose of illustration, it shall be assumed that the user has the goals of getting out of debt and buying a house. The goal of buying a house may be further broken down into the goals of saving $60K for the down payment, and obtaining a $240,000, 30 year mortgage that requires no more than $60K down payment and has monthly payments under $1,100.

When multiple goals are specified, the goals may complement each other, interfere with each other, or be entirely independent of each other. For example, goals such as getting out of debt and refinancing a loan at a lower interest rate tend to complement each other, because tasks that further the achievement of one goal tends to further the achievement of the other. A similar situation occurs when the goals are lowering one's blood pressure and losing weight.

In the example of buying a house and getting out of debt, the goals tend to interfere with each other. Specifically, money used to pay down a credit card is not available for saving for a down payment, and visa-versa. When such is the case, the mobile application may provide controls that allow the user to assign priorities to the goals. The priorities may be specified in terms of the sequence in which to achieve the goals (buy house, then get out of debt), or in other terms (buying house has an importance of 8, while getting out of debt has an importance of 6). In the case where goals are prioritized, the tasks in the event timeline are selected and timed in a manner to give priority to those tasks that further higher priority goals.

For example, if buying a home has higher priority than getting out of debt, tasks associated with paying down credit balances may be less aggressively timed than if getting out of debt had the higher priority. For example, if buying the house has greatest priority, tasks for the paying down of debt may be spread over a ten year period that ends well after the goal of buying a house would be achieved, If getting out of debt has higher priority, the tasks for paying down the debt may be aggressively placed in a single year, with the achievement of buying the house scheduled for a year after the debt is eliminated.

### The Event Timeline

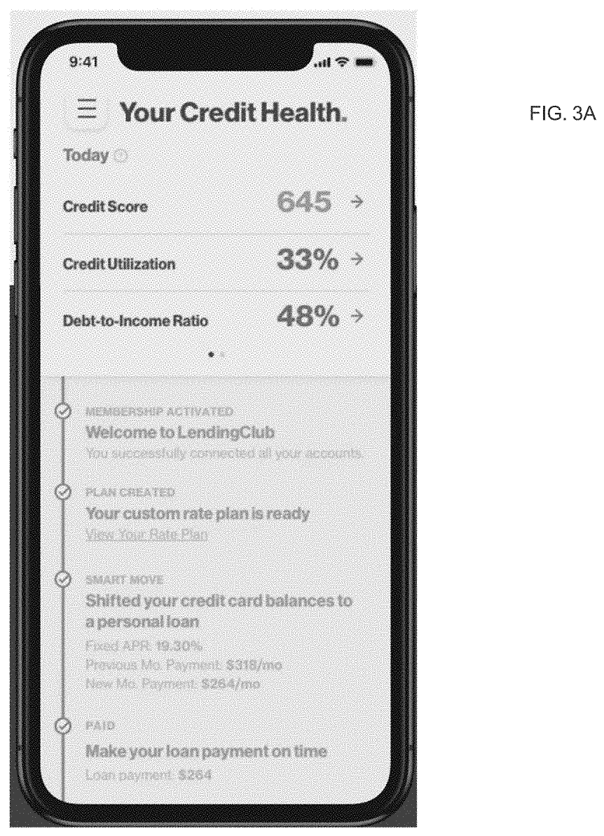

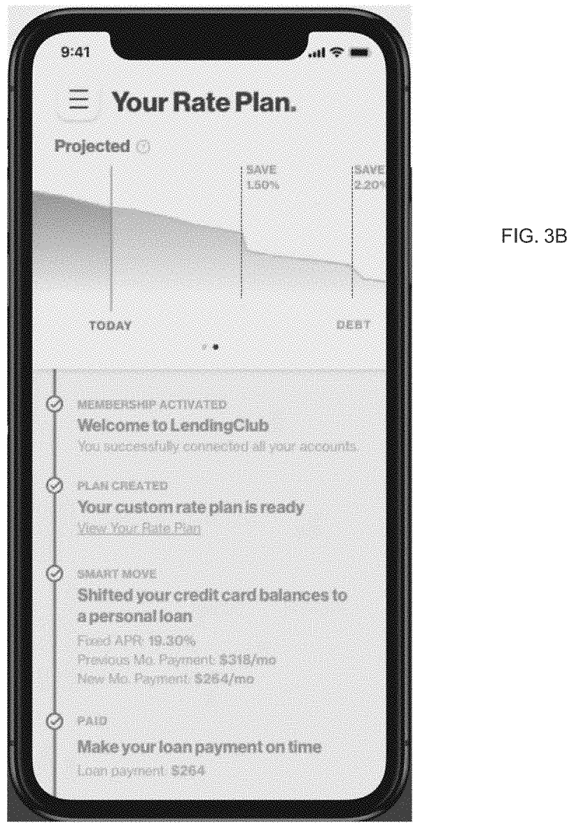

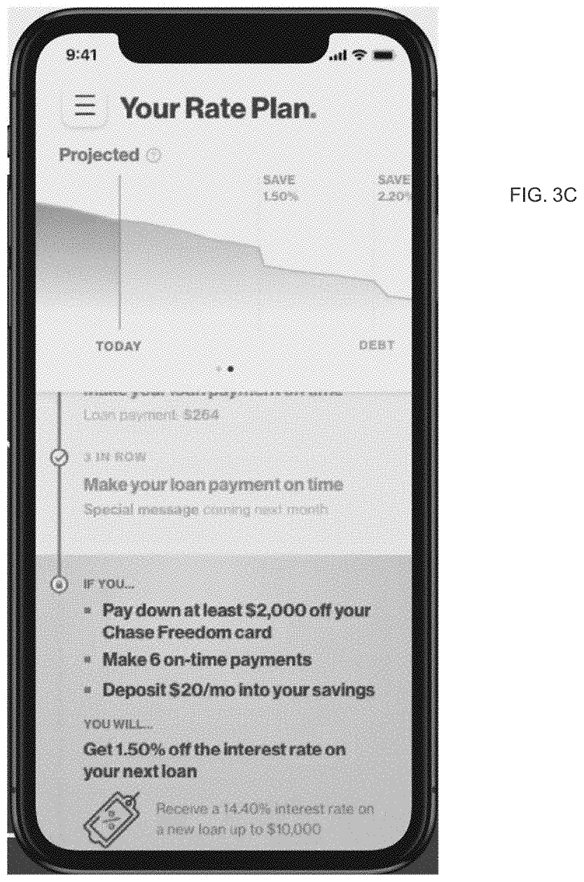

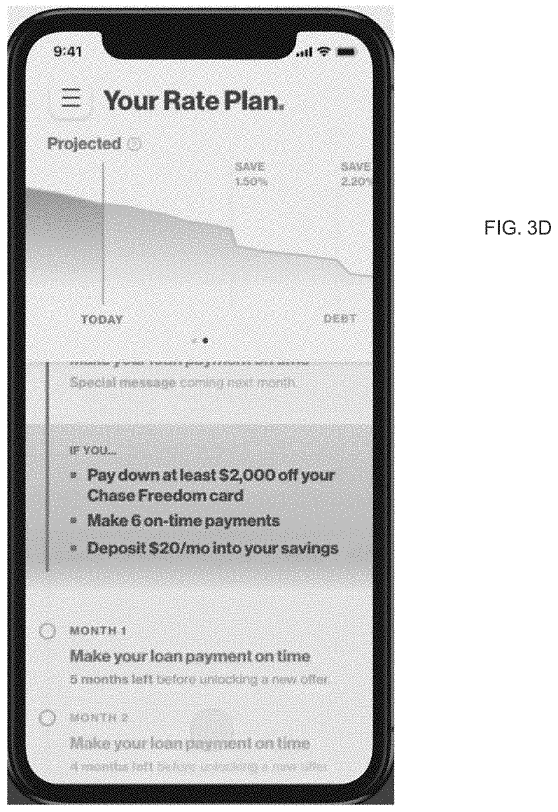

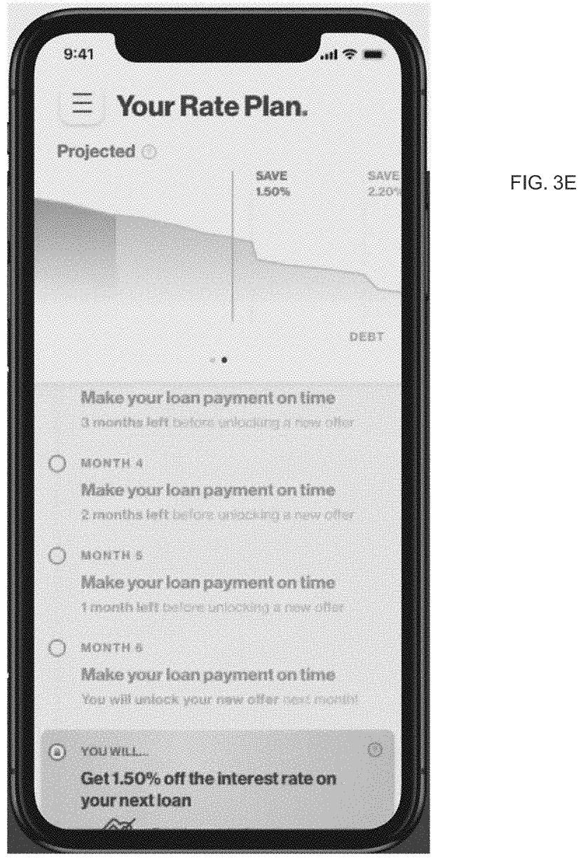

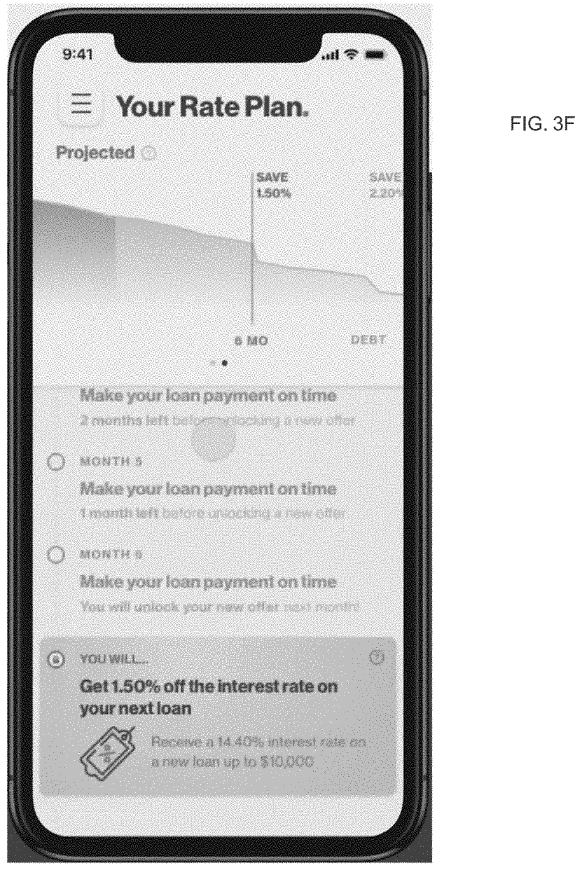

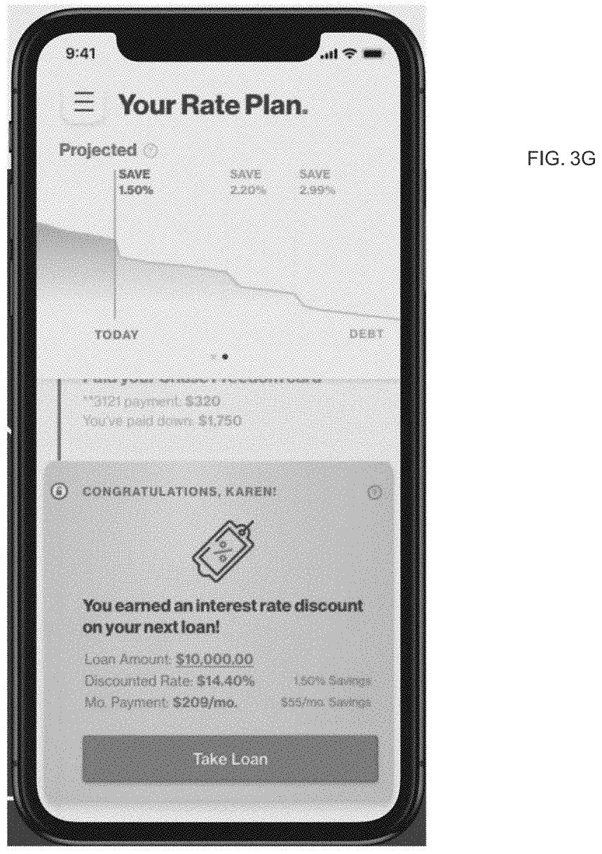

According to one embodiment, while on the “Your Credit Health” screen (see FIG. 2A), a user is able to swipe to lower portion of the screen to bring up the event timeline interface, as illustrated in FIG. 3A. The event timeline provides a clear path to achieving the user's specified goal(s). In other words, the event timeline indicates both the “how” and “how long” associated with achieving each specified goal.

According to one embodiment, the event timeline depicts that path as a sequence of events that must occur to achieve the specified goal. Some event entries in the timeline may be task events that depict actions the user must affirmatively perform in furtherance of the specified goal. For example, the event timeline may have a task entry at each point in the timeline where the user is to make a payment on an existing loan. In addition, the event timeline may have event entries for things tasks such as making payments of certain amounts to lower credit card balances, etc.

Other event entries in the event timely may simply communicate events that will occur when those tasks associated with the task events are performed. For example, some event entries may indicate when the user qualifies for a lower interest rate on a loan, qualifies for a reward or promotion, etc. For example, an event entry may indicate “receive a $50 gift card for making six consecutive loan payments on time”. The location of such a reward event entry may be, for example, immediately following the sixth “make loan payment” task entry on the event timeline. In the case where the user makes a late payment, the location of that reward event entry would automatically shift down to a position immediately after six more loan payment task entries.

Referring again to FIG. 3A, it illustrates a portion of the timeline that includes past events. In the illustrated example, the oldest entries are on top, with the first event entry being the activation of the user's account. The second oldest event in the timeline is the creation of a plan for the user. The third event indicates that the user moved credit card balances to a new personal loan. Finally, the last entry illustrated in FIG. 3A indicates that the user had a task entry for paying the first payment of the loan, and that the user performed the specified task on time. Showing past events in the event timeline helps the user appreciate what events have led up to the user's current situation and how well the user has followed the plan created by the service so far.

### The Metric Timeline

Referring to FIG. 3B, it illustrates a dual-timeline interface that includes the event timeline illustrated in FIG. 3A. According to one embodiment, the metric timeline may be displayed in the upper portion of the screen, as illustrated in FIG. 3B, when a user horizontally swipes across the top of the screen illustrated in FIG. 3A. As mentioned above, the metric timeline shows the values of one or more metrics that are related to the user's goals. In the example illustrated in FIG. 3B, the metric timeline has a chart showing the value of user debt over time. The metric timeline has a vertical line (the “now-line”) that represents the current point in time. The point at which the now-line intersects with a metric line indicates the current value of the metric. Thus, the current debt of the user is indicated by the point at which the now-line intersects with the “debt amount” line.

The portion of the metric timeline that is to the right of the now-line depicts how the value of the metric is predicted to change if the tasks specified in the event timeline are performed. As would be expected, the “debt amount” line falls as time passes, since the timeline includes tasks associated with achieving the goal of getting out of debt. The metric timeline further includes information relating to the metric “interest rate”. Specifically, the metric timeline indicates a particular point on the timeline where the user's interest rate is projected to fall 1.5%, and another point further in the metric timeline where the user's interest rate is project to fall 2.2%.

### Future-Reward Entries and Reward-Earned Entries

The event timeline does not merely indicate past events that relate to the goals specified by the user. As mentioned above, the event timeline further includes (a) entries for future tasks the user must perform to achieve the goals and/or (b) future-reward entries that represent rewards for which the user will qualify if the user performs certain tasks (which may themselves be specified in the future-reward entry).

For example, FIG. 3C illustrates the dual-timeline interface of FIG. 3B after the user has scrolled the event timeline up to reveal a future-reward entry. In the example illustrated in FIG. 3C, the event timeline includes a future-reward entry that says “If you pay down at least $2000 off your Chase Freedom Card, and Make 6 on-time payments, and Deposit $20/month into your savings, you will get 1.5% off the interest rate on your next loan”. This future-reward entry in the event timeline is positioned at a location that corresponds to the “Save 1.5%” indicator on the metric timeline. Further, the predicted portion of the chart of the “debt” metric assumes that the user will perform the tasks necessary for qualifying for this reward, and then uses the reward to lower the user's debt. The tasks of making on-time payments, paying down the credit card, and making the deposits in savings may additionally show up as separate task entries within the event timeline.

According to one embodiment, the future-reward entries that are generated on a user's event timeline are based on the data that the service receives from its various data sources, as well as the products that the provider of that service has available. In the present example, the provider of the service is a lending company, so the available products include loans. Based on the information obtained by the service from its own sources and third-party sources about the user's financial health, the service determines which rewards a user may qualify for in the future.

In one embodiment, the interface presents a control (e.g. a button) on each reward entry that may be activated by the user. Activation of the control of a reward entry indicates that the user intends to achieve the reward. In response to the activation, the reward entry may be replaced by tasks entries for performing the tasks to achieve the reward, and a “reward-earned entry” after the last of those task entries. The reward-earned entry may include a control that can only be activated after the corresponding task entries have been accomplished. Activation of the control on the reward-earned entry may cause the user to receive the corresponding reward. For example, activation of the control on the reward-earned entry may cause the user to receive a gift card, or initiate the application for a loan with the improved interest rate.

According to one embodiment, when determining which tasks a user must perform to qualify for a reward, the service selects among tasks whose performance will be reflected in the information that the service gathers from sources other than the user himself/herself. By selecting tasks whose performance is reflected by data gathered from sources other than the user, the service avoids the need to rely on the user's own input to determine whether the prerequisites to a reward have been satisfied. In the present example, the service determines whether the user has paid down the credit card, makes on-time payments, and deposits money into a savings account based on information obtained from the companies that control those accounts and/or a credit bureau.

The future-reward entries that are placed in may relate directly to the user's primary goal (e.g. qualify for a $300,000 mortgage with under 4% interest rate within six months) or to related goals. For example, a future-reward entry may say “if you get your credit score to 700, and save at least $60,000 within six months, you will be awarded such a loan within six months”. On the other hand, the future-reward entry may simply be “save at least $60,000 within six months, and receive a gift certificate for $300.”

### Scrolling the Dual-Timeline Interface

In the dual-timeline interface illustrated in FIG. 3C, the event timeline has been scrolled to a future-reward entry that is currently available. Consequently, the now-line is still on “today” (indicating the current day). As the event timeline continues to be scrolled to indicate future event entries, the now-line will also scroll to corresponding points in the future. For example, FIG. 3D illustrates the dual-timeline interface of FIG. 3C where the user has scrolled to reveal to task events for tasks to be performed in the future. Specifically, approximately one month from the current day, the user is to make a payment of the loan. Approximately two months from the current day, the user is to make another payment of the loan. Each of these tasks is reflected in a corresponding task entry at the bottom of the event timeline in FIG. 3D.

FIG. 3E illustrates the dual-timeline interface after the user has scrolled further into the portion of the timeline that represents the future. As illustrated in FIG. 3E, additional task entries (loan payments for additional future months) have been revealed. In addition, another future-reward event entry has started to be revealed. Since the user has scrolled beyond the portion of the event timeline that corresponds to the current day, the now-line of the metric timeline has also moved to a corresponding point in the future.

FIG. 3F illustrates the dual-timeline interface of FIG. 3E after the user has scrolled to completely reveal a reward-achieved entry that is located at a position six months in the future. In response to the scrolling of the event timeline, the now-line of the metric timeline has scrolled to a point that is six months in the future.

FIG. 3G illustrates the dual-timeline interface of FIG. 3E after the six months have passed and the user has performed all tasks necessary to achieve the specified reward. In FIG. 3G, the reward entry corresponds to the current time, as indicated by the fact that the now-line coincides with “today”. Because the user has performed the tasks required to achieve the reward that corresponds with the reward entry, the reward entry congratulates the user and provides a control which, when selected, initiates the process for obtaining the reward (in this case, a loan with a lower interest rate).

In the examples given above, the event timeline was scrolled to events in the future, and the now-line automatically scrolled in sync so that the now-line indicated the predicted value of the metric at the future time that corresponds to the highlighted entry within the event timeline. According to one embodiment, The now-line and the active event entry stay in sync regardless of which timeline is manipulated by a user, and regardless of the direction of manipulation. Thus, after having scrolled to the event entry six months from present, scrolling back to the event entry that represents the current month would cause the now-line of the metric timeline to scroll back to the “today” point. Similarly, controls may be provided to move the now-line left and right within the metric timeline. Such movement automatically causes the events within the event timeline to scroll to entries whose timing corresponds to the timing indicated by the current position of the now-line.

### Real Time Tracking and Dynamic Adjustments

As mentioned above, it is preferable that the tasks assigned to a user to achieve a goal and/or receive a reward are tasks whose performance will be reflected in data obtained by a party other than the user him/herself. For example, performance of a task of adding $20 to a savings account each month may be determined by obtaining information from the financial institution that provides the savings account. Similarly, performance of a task of walking a mile three times a week (for a health-related goal) may be determined through data obtained from wearable monitoring devices, smart sporting equipment, etc. Performance of tasks related to medical tests (e.g. lowering the blood sugar) may be obtained from lab results (after obtaining the necessary user permissions).

The original plan to achieve the user's goals, as reflected in the tasks in the user's event timeline, is only good as long as the user is performing the tasks listed therein. In response to detecting non-compliance with a specified tasks, the plan is automatically updated and the event timeline is modified accordingly. For example, if the data shows that instead of adding $20 to the savings account in a particular month, the user instead drained the entire account to buy a new car, the system must generate a new plan for achieving the user's specified goals based on the new information obtained from the data sources (in this case, the information from the bank that has the savings account and/or a credit bureau). In the present example, the purchase of the new car (and the draining of the savings account) would inevitably result in a revised plan in which eliminating debt and buying a new house would occur later than was predicted in the initial plan.

In some situations, even if a user complies with all tasks specified in a plan, it may be necessary to dynamically modify the plan based on new information. For example, if a user's income source unexpectedly disappears (e.g. the user loses a job) gets entangled in an expensive lawsuit, the user may no longer qualify for the interest rate reductions in the timing that was initially predicted. Thus, upon becoming aware of the such changed circumstances, the service adjusts that plan accordingly. The goals themselves need not change (e.g. the goals may still be to get out of debt and buy a home), but the content and/or timing of the tasks to achieve the goals (as well as the content/timing of tasks to achieve related rewards) may change.

### Multi-Metric Timeline

In the example given above the metric timeline showed a single metric (amount of unsecured debt) for a single goal (get out of debt). However, in other embodiments, the same metric timeline can show multiple metrics. Such a multi-metric display may be particularly useful when the metric/goals are related. For example, assume that a user desires to spend a year travelling the world. To achieve this goal, the user may have two corresponding financial goals for reducing debt to a certain level, and saving enough for the intended trips. In such a situation, the metric timeline may include on line showing the predicted amount of debt, and another line showing the predicted amount of savings. The user's “plan” would include both tasks for paying down debt, and tasks for adding to a saving's account. Consequently, the prediction chart for the debt metric would be expected to go down over time, while the prediction chart for the savings balance would go up.

Instead of or in addition to multi-metric timelines, the mobile application may allow the user to view multiple variations of metric timelines that show how different metrics vary over time. The techniques described herein are not limited to any particular metrics, nor any particular type of chart for showing how those metrics are predicted to change over time if the user performs the tasks indicated in the event timeline.

### Third-Party Rewards

In the examples given above, the user is presented with reward entries for rewards that correspond to products of the company that provides the service used by the mobile application. However, the rewards entries are not limited to rewards provided by that company. For example, third parties may periodically provide that company with data that specifies reward-triggering-criteria and corresponding rewards. The user interface may present reward events in the event timeline of a user when the service determines that user, if the user performs certain tasks, the user will satisfy the reward-triggering-criteria associated with a third-party reward. Such a reward event may indicate that, if the user satisfies performs the tasks that will satisfy the criteria, the user will receive the corresponding third-party reward.

If the user indicates an interest in that reward, the mobile application updates the event timeline of the user to include task entries needed to achieve the third-party reward, and a reward-achieved entry. Initially, the reward-achieved entry will be locked. Upon completion of the requisite tasks, the reward-achieved entry is unlocked and the user is presented with a control which, when activated, initiates the process for obtaining the reward from the third party.

According to one embodiment, in addition to reward-triggering-criteria and reward information, the third-party also specifies the appearance of the reward event record. Thus, the third-party branding and logo may be reflected in the reward entry that is presented to the user within the user's event timeline.

### Adding/Removing/Modifying Goals

As mentioned above, the dual-timeline interface may be used to facilitate the achievement of multiple goals. However, it is not uncommon for a user's goals to change over time. For example, a user may specify a goal of saving up money to buy a new car. Prior to achieving that goal, the user may come across a used car that the user can buy for cash. After buying the car, the user may drop the goal of saving up for the new car. According to one embodiment, the mobile application provides controls that allow the user to drop previously stated goals. In response to dropping a goal, the tasks entries related to that goal are removed from the event timeline. In addition, the tasks for other goals may be affected. For example, the availability of the money that had accumulated for the purchase of the new car may cause tasks for saving money for other goals to be changed. Further, the newly available money may reduce the predicted timing for achieving other goals, such as saving up for a down payment on a home.

Controls are also provided to add new goals for a user. The addition of new goals will typically cause new task entries to be added to the user's event timeline, and may cause the tasks and/or timing of additional goals to change.

Changes made to goals will also trigger modifications to the goals-achievement plan generated by the service for a given user. Such plan changes cause changes to the content of the user's event timeline. For example, a user may decide that a million dollar home is too extravagant, and decide to instead save up for a $50,000 cabin in the mountains. Such a change to the “home purchase” goal would result in significant changes to the tasks and timing of the entries within the user's event timeline.

Even if the goals themselves don't change, the user may change his/her mind about the priority of the goals. As mentioned earlier, a change in the priority of the goals may significantly affect the order and timing of tasks in the user's event timeline.

Whether an event timeline change is caused by the addition of a goal, the removal of a goal, the modification of a goal, or a change in goal priority, such changes will also trigger changes to the metric timeline. For example, the availability of money that was previously being saved to purchase of a new car may be used to significantly decrease the timing for becoming debt free, as illustrated in the chart for the “debt amount” metric.

### Excluding or Adding Information

As mentioned above, the service formulates a plan for achieving the user's specified goals based on information obtained by the service from data sources other than the user him/herself. In the case of financial goals, those sources may include, for example, credit bureaus. However, there are situations in which additional information may be needed for an accurate picture of the user's situation, or when some of the information from the sources should be excluded from consideration.

An example of a situation in which additional information may be required is when a user has obtained a $20,000 loan from a sibling. That loan may not be reflected in the data from any automated source, but is still highly relevant when formulating a plan that involves achieving certain financial goals, such as becoming debt-free. To account for such information, the mobile application includes controls that allow the user to specify information that is otherwise unavailable to the service associated with the mobile application. Any such information is then taken into account when formulating a plan to help the user achieve the user's specified goals.

As another example, a user may own title to a car. The user may provide information about the title to the application. For example, the application may provide controls for scanning an image of the title document itself. The fact that the user owns title to the car may be used by the automated service in a variety of ways. For example, based on the fact that the user owns a car, the service may generate a plan in which the user obtains a relatively low interest rate loan on the car and to pay down the balance of relatively high interest rate credit cards. Without knowledge of the car, the service would not have the knowledge required to include such a task in the user's plan.

An example of a situation in which information should be excluded is when a user has been the victim of identity theft. In such situations, the user may be actively taking steps to have fraudulent information removed from the user's credit report. However, until the information is removed, any plan that is generated based on the credit report will be based on inaccurate information. In such situations, the user is provided controls that allow the user to exclude from consideration the information within the credit report that is based on the fraudulent activity. In some embodiments, the operators of the service may perform an independent investigation into the issue before excluding information that the user has requested to be excluded. Such investigation may ensure, for example, that the user will not be presented with offers/rewards for which the user does not actually qualify.

### Informational Entries

In addition to task entries, goal entries, future-reward entries and reward-achieved entries, the event timeline may include informational entries. An information entry is an entry that merely conveys information that may be of interest to a user. For example, in a situation in which the user has a goal of getting out of debt, the majority of the user's debt may be on a particular credit card. Under these circumstances, the user may desire that the event timeline include informational entries that indicate information about that credit card account. For example, immediately after a task entry to pay down $500 on the balance of the credit card, the event timeline may include an informational entry that shows what the remaining balance will be on that credit line after the preceding tasks have been performed. In this manner, the event timeline will not only indicate what the user must do, but also convey information about the immediate effect of those actions.

According to one embodiment, the interface provided by the mobile application allows the user to drag one or more images that represent user accounts (e.g. credit cards, loans, etc.) onto the event timeline. In response, the mobile application adds to the timeline, in the designated location, an informational entry that indicates the predicted status of the account at the time the corresponds to the selected location in the timeline.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

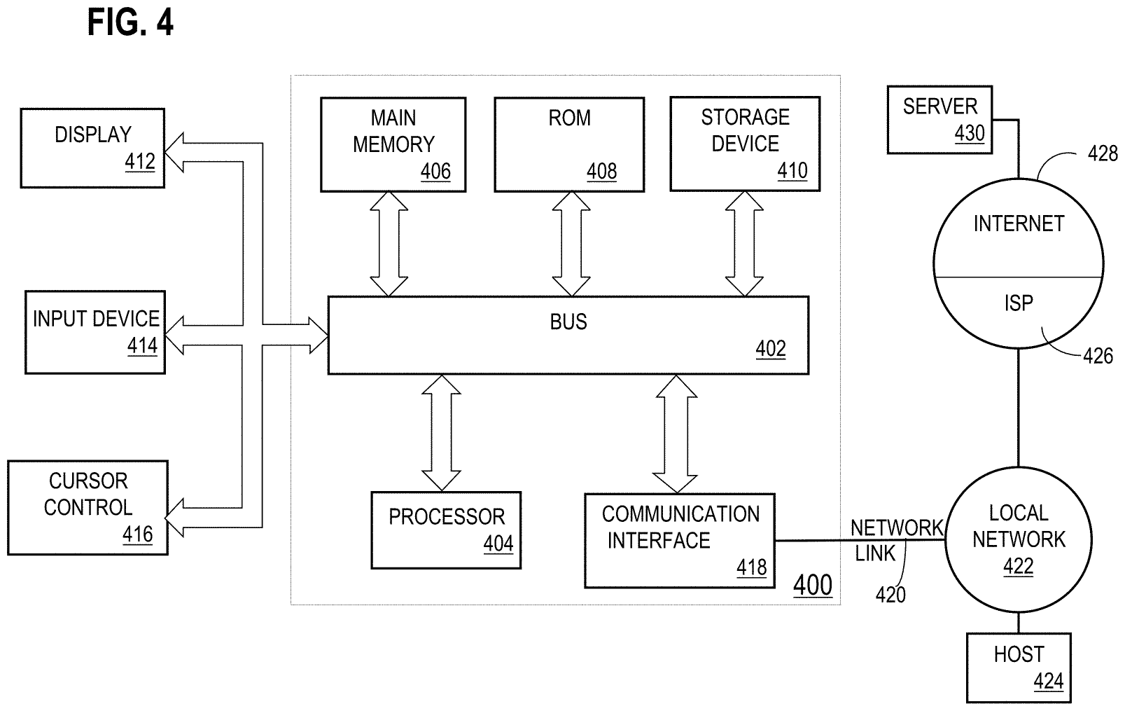

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, from a user, at an application executing on a computing device, user input that indicates one or more goals;
obtaining, at an automated service associated with the application, information from one or more sources other than the user, wherein the information conveys a current state of the user relative to the one or more goals;
determining, at an automated service, a plan for the user to achieve the one or more goals;
where determining the plan includes:
determining one or more tasks for the user to perform to achieve the one or more goals;
determining a timing for each of the one or more tasks;
determining a timing for achieving each of the one or more goals if the user performs the one or more tasks at times indicated by the respective timings determined for the one or more tasks;
generating, by the application on a display associated with the computing device, an event timeline that includes a plurality of chronologically ordered entries;
wherein the plurality of entries includes an entry for each of the one or more tasks and an entry for each of the one or more goals;
wherein the plurality of chronologically ordered entries are ordered based on the timings determined for the respective task or goal that corresponds to the entry;
after determining the plan, periodically obtaining, by the automated service, new information from the one or more sources;
based on the new information, determining whether the user has performed a particular task of the one or more tasks in compliance with the timing associated with the task; and
generating, by the application on the display, the event timeline in a manner that visually indicates whether the user has performed the particular task in compliance with the timing associated with the task.

2. The method of claim 1 wherein:
the user has performed the particular task in compliance with the timing associated with the task; and
generating the event timeline in a manner that visually indicates whether the user has performed the particular tasks includes displaying the entry for the particular task with a visual indication that the particular task has been performed in compliance with the timing associated with the task.

3. The method of claim 1 wherein:
the user has not performed the particular task in compliance with the timing associated with the task;
the method further includes determining, at the automated service, a revised plan for achieving the one or more goals; and
generating the event timeline in a manner that visually indicates whether the user has performed the particular tasks includes generating the event timeline based on the revised plan.

4. The method of claim 1 wherein:
the one or more goals include a plurality of goals;
the method further comprises receiving, at the application, user input that assigns priorities to the plurality of goals;
determining the plan is performed based, at least in part, on the priorities assigned to the plurality of goals;
the method further comprises:
receiving, at the application, user input that changes the priorities assigned to the plurality of goals; and
responsive to the user input that changes the priorities assigned to the plurality of goals, determining a revised plan for achieving the one or more goals based, at least in part, on the changed priorities assigned to the plurality of goals; and
generating the event timeline to reflect the revised plan.

5. The method of claim 1 wherein:
the one or more goals include a particular goal;
the user input that indicates one or more goals includes user input that specifies timing for achieving the particular goal; and
determining a plan includes determining tasks, and timing for the tasks, for achieving the particular goal in compliance with the timing specified for achieving the particular goal.

6. The method of claim 1 further comprising:
receiving user input that specifies a particular degree of sacrifice;
wherein determining the plan includes determining the one or more tasks, and timings of the one or more tasks, based on the particular degree of sacrifice;
receiving user input that specifies a revised degree of sacrifice; and
determining a revised plan in which the one or more tasks, and timings for the one or more tasks, are based on the revised degree of sacrifice.

7. The method of claim 1 wherein:
presenting the user with an offer to obtain a particular reward, where the offer identifies one or more conditions for obtaining the reward;
receiving user input that indicates that the user accepts the offer;
responsive to receiving the user input that indicates that the user accepts the offer, updating the event timeline to by adding task entries for satisfying the one or more conditions, and a reward-achieved entry that corresponds to the reward.

8. The method of claim 7 wherein presenting the user with an offer is performed by adding, to the event timeline, a future-reward entry that identifies the one or more conditions and the reward.

9. The method of claim 7 wherein:
the reward-achieved entry includes a control which, when activated, initiates a process for obtaining the reward; and
the control for obtaining the reward is inoperable until the user has performed the tasks for satisfying the one or more conditions.

10. The method of claim 7 wherein:
the offer is an offer from a third-party;
the third-party has provided the automated service criteria for presenting the offer; and
the automated service caused the offer to be presented to the user responsive to determining that, based on the information from the one or more sources, the user satisfies the criteria.

11. The method of claim 1 further comprising:
displaying, concurrent with the event timeline, a metric timeline that includes a chart of a metric associated with a particular goal of the one or more goals;
wherein the metric timeline includes a future portion of the chart that reflects predicted future values of the metric based on the user performing the tasks specified in the event timeline in compliance with each task's respective timing.

12. The method of claim 11 wherein:
the metric timeline includes a now-line; and
the method further comprises moving the now-line in the metric timeline in sync with the user scrolling the event timeline such that the now-line indicates a time associated with a currently-selected event entry.

13. The method of claim 1 further comprising:
receiving user input that indicates that certain information should be excluded for the purpose of formulating a plan to achieve the one or more goals; and
wherein the information received from the one or more sources includes the certain information; and
wherein determining the plan is based on the information from the one or more sources after having excluded the certain information.
